(19) United States
(12) Patent Application Publication
(10) Pub. No.: US 2009/0287801 A1
(43) Pub. Date: Nov. 19, 2009

(54) Multicomputer System and Method for the Configuration of a Multicomputer System

(76) Inventor: Klaus Hartung, Salzkotten, DE (US)

Correspondence Address: SLATER & MATSIL, L.L.P., 17950 PRESTON RD, SUITE 1000, DALLAS, TX, 75252-5793, US

(21) Appl. No.: 12/432,190

(22) Filed: Apr. 29, 2009

(30) Foreign Application Priority Data
May 16, 2008 (DE) 10 2008 023 846.5

(51) Int. Cl. G06F 15/177; G06F 15/16

(52) U.S. Cl. 709/220; 709/224; 709/223

(57) ABSTRACT

To configure a multicomputer system with a plurality of computers, at least one computer group is set for providing each service, wherein a first one of the computers, on which runs an agent, assigned to the corresponding service and the corresponding computer group, is assigned to each computer group. A request from at least one of the agents is received by a central control unit. The request concerns the provision of at least one additional computer to the computer group to which the requesting agent is assigned. An assessment value is determined for each of a plurality of possible configurations of the multicomputer system that satisfy the request. From the set of determined assessment values, a superior assessment value is determined. The multicomputer system is then configured in a configuration associated with the superior assessment value.

This application claims priority to German Patent Application 10 2008 023 846.5, which was filed May 16, 2008 and is incorporated herein by reference.

### TECHNICAL FIELD

The invention relates to a multicomputer system with a plurality of computers for providing services via a network and also to a method for the configuration of such a multicomputer system with respect to providing the services.

### BACKGROUND

In a multicomputer system, the computers, frequently also called servers, are designed to provide services via a network, wherein these services can be used by users, also called clients, through the transmission of a corresponding request to the computers. In this way, an array of various services is known, for example, data file, Web, or database services.

In large multicomputer systems of this type, also designated as server farms, frequently several hundred or thousand computers are operated. In order to be able to realize configuration and management tasks in such a multicomputer system with justifiable expense, increasingly automated configuration and management methods are required. The approach for automating configuration and management tasks is also known as “autonomous computing.” Typically, for this purpose a central control unit is provided that determines, with reference to given criteria, how many and which of the computers of the multicomputer system should be used for providing the various services. The central control unit can be designed to define or, if necessary, also change a corresponding configuration.

Defining the configuration to be assumed is frequently based on a comparison between the demands for individual services, the quality, also called performance, with which the demands can be performed, the number of computers already applied to a service, and also the total available computer capacity. One example for the quality with which a service is provided is the response time, that is, the time in which a service answers an incoming request. In addition, other non-technical but economical considerations can be taken into account, for example, different priority levels of customers that use the services of a network service provider operating the multicomputer system. Known methods for the automatic configuration of multicomputer systems frequently use a plurality of decision criteria that are often specific to the service to a large degree. Consequently, the criteria are not comparable with each other, which can lead to unforeseeable effects in the automatic configuration. This can require the extensive manual intervention of an administrator for the configuration of the multicomputer system. Ultimately, for this reason, the consideration of service-specific criteria is often abandoned.

### SUMMARY

In one aspect, the present invention specifies a method for the configuration of a multicomputer system that is highly automated and that optimally distributes the available computers to the services to be provided. In another aspect the present invention specifies a multicomputer system that is suitable for executing such a method.

According to a first aspect of the invention, the problem is solved by a method for configuring a multicomputer system with a plurality of computers, wherein this method features the following steps. At least one computer group is set for providing each service, wherein initially one of the computers, on which is executed an agent associated with the respective service and the corresponding computer group, is assigned to each computer group. A request from at least one of the agents is received by a central control unit, wherein the request concerns the provision of at least one additional computer to the computer group assigned to the requesting agent. An assessment value is determined for a plurality of possible configurations of the multicomputer system satisfying the request. From the set of calculated assessment values, a superior assessment value is determined. The multicomputer system is then configured in a configuration appropriate to the superior assessment value.

In a method, the management of the computers is divided into the management performed by the agent within the computer groups and the management of the computer groups by the central control unit. The relatively large autonomy that the agents have with respect to the management of the computers assigned to them also produces in the multicomputer system a high error tolerance for the loss of the central control unit and decreases the load on the control unit, thereby making this control unit suitable for connecting a plurality of agents.

Determining one assessment value for a configuration allows the possible configurations to be easily compared to each other, wherein competing demands for different services can be considered in a uniform way.

In one advantageous embodiment of the method, the request concerns the provision of exactly one additional computer. In this way, the method can be realized in a particularly simple manner.

In another advantageous embodiment of the method, a tolerance value is set and the multicomputer system is configured in the superior configuration in the last step of the method named above only when the associated assessment value is less than the tolerance value. In this way, a two-step decision process is realized in which, at first, from the set of possible configurations, the best-suited, superior configuration is sought (a relative criterion), but this configuration is assumed only if it has an assessment value lying below the tolerance value (an absolute criterion). The two-step decision process makes the control behavior of the method predictable, wherein the risk of an undesired control behavior that causes, for example, oscillations, is reduced. The method is thus especially well-suited for automatic execution.

In another advantageous embodiment of the method, service relevance values are set for the services, and the assessment values for a possible configuration are defined as a function of the service relevance values.

In another advantageous embodiment of the method, performance classes that characterize the suitability of a computer for performing a service are set for the computers and the services. The assessment value for a possible configuration is defined as a function of the performance classes that are assigned to the computers and to the services to be provided by the computers according to the assignment to the computer groups.

By means of the service relevance values and the performance classes, specific requirements of the services and features of the computers can be easily incorporated into the assessment values.

In another advantageous embodiment of the method, the assessment value for a possible configuration is defined as a function of a time period that has elapsed since the reconfiguration of a computer provided in the possible configuration for providing a service. In this way, it is achieved that the history of the reconfiguration of the multicomputer system enters into the assessment values. This reduces oscillations in the control behavior.

According to another aspect of the invention, the problem is also solved by a multicomputer system and a computer program that are suitable for executing the described method. The advantages correspond to those of the first aspect.

### BRIEF DESCRIPTION OF THE DRAWINGS

The invention will be explained in greater detail below with reference to embodiments with the aid of the figures.

FIG. 1, shows a schematic diagram of the structure of a multicomputer system;

FIG. 2, shows a flow chart of a method for the configuration of a multicomputer system;

FIG. 3, shows a tabular diagram of possible configurations of the multicomputer system shown in FIG. 1;

FIG. 4 provides a table of penalty points used in the configuration of a multicomputer system; and

FIGS. 5a and 5b, show schematic diagrams of the structure of other multicomputer system.

The following list of reference symbols may be used in conjunction with the drawings:

A1-A3 Agent

AA Agent adapter

D1-D3 Service

DI Service instance

DR Service relevance value

DS Data storage

G0 Additional computer group

G1-G3 Computer group

K Configuration

Kmin Superior configuration

LK Service class

O Orchestrator

P Assessment value

Pmin Superior assessment value

Ptol Tolerable assessment value

Pok Threshold

p(R, G) Partial assessment value

R1-R7 Computer

Rq Request

s Penalty point

S Structure instruction

V Management unit

w Penalty value

z Central control unit

### DETAILED DESCRIPTION

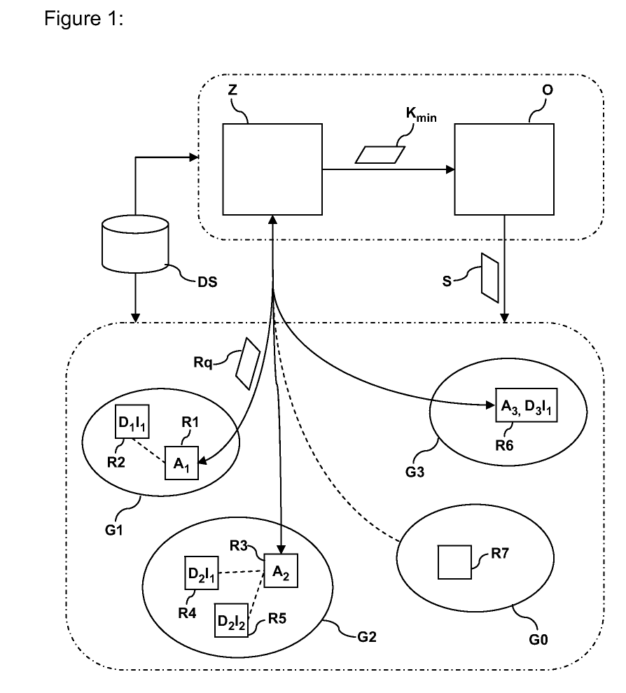

In FIG. 1, the structure of a multicomputer system is shown schematically. The multicomputer system includes seven computers R1-R7 that are available for providing services to users of the multicomputer system via a network. The computers R1-R7 are logically assigned to three computer groups G1, G2, G3, and also an additional computer group G0. The computer group G1 includes the computers R1 and R2, wherein an agent A1 runs on the computer R1 and a service instance D₁I₁ runs on the computer R2. The group G2 includes the computers R3, R4, and R5, wherein an agent A2 runs on the computer R3 and service instances D₂I₁ and D₂I₂ run on the computers R4 and R5, respectively. The computer group G3 includes the computer R6, on which an agent A3 and a service instance D₃I₁ are executed. The additional computer group G0 includes the computer R7 that is not used at the point in time shown. The agents A1, A2, and A3 of the groups G1, G2, and G3, respectively, are connected to a central control unit Z for transmitting requests Rq. The central control unit Z is connected to an orchestrator O for transmitting a configuration Kmin. The orchestrator O is connected, on its side, to the computers R1-R7 for transmitting structure instructions S. The central control unit Z and the orchestrator O and also the computers R1-R7 have access to a common data storage DS.

Below, reference symbols without an index designate the entirety of the corresponding elements or an element of the totality that is not further specified. The term “computer R” can relate, for example, to the set of computers R1-R7 or to a computer from the set of computers R1-R7 that is not designated in more detail.

The multicomputer system shown in FIG. 1 includes, as an example and for reasons of clarity, only the seven computers R1-R7, and is set up at the point in time of the illustration for providing three services D1, D2, and D3 by the computer groups G1, G2, and G3. The number of seven computers R and three services D is to be construed as merely an example and is in no way limiting. The method shown in the scope of this application for the configuration of a multicomputer system is especially suited for large multicomputer systems, possibly including a few thousand computers and providing a plurality of services. It is advantageous, but not compulsory, that the computers R involve so-called blade servers that feature, in addition to one or more processors, also at least one working memory and interfaces for network connections, and that greatly simplify the administration through their uniform construction. A local nonvolatile data storage, for example, a magnetic hard-disk drive, can be provided but is not compulsory. As an alternative to the local nonvolatile data storage, a central data storage with access via a network can be provided. The data storage DS shown in FIG. 1 can act as a central data storage, or another data storage can be provided in the form of a network memory (Network Attached Storage, NAS).

A network connection of the individual computers R is not shown in FIG. 1 for reasons of clarity. By means of a network connection, the computers R are connected both to the users that demand the services of the multicomputer system and also to the central control unit Z, the orchestrator O, and optionally to a central data storage. For security reasons, separate networks are often used, one of which is public and makes the computers R accessible to the users of the multicomputer system, optionally via one or more distributors (also called routers or switches). The other, nonpublic network is used for connecting the computers R to the central control unit Z and to the orchestrator O. By means of the nonpublic network, the computers R can also access a central data storage. Alternatively, it is possible to provide a third network for this data storage access (Storage Area Network, SAN). Here, the separation into several networks can be of a physical nature or it can involve merely a logical separation of only one physical network into several regions, for example, by means of different address spaces.

The service actions, called services D for short, demanded by the users of the multicomputer system are provided by the so-called service instances DI that are executed on some of the computers R. For each service, at least one of these service instances DI is provided. The service instances DI are software applications that are designed to receive, process, and, if necessary, send back a reply to requests received via a network.

As an example, in the embodiment of FIG. 1, let the service D1 be a Web service that generates and sends back a Web page for a corresponding request, let the service D2 be a database service that stores data in a database or outputs data from this database or manipulates data in this database according to a corresponding request, and let the service D3 be a backup service that creates, upon request, a safe copy for user-specific data or database contents. In the embodiment of FIG. 1, at the point in time of the illustration, for providing the service D1, only the one service instance D₁I₁ is provided; for the service D2, the service instances D₂I₁ and D₂I₂ are provided, and for the service D3, the service instance D₃I₁ is provided. For the designation of the service instances DI, the first index designates the service. The instances provided for one service are distinguished by the second index. A service instance DI can run on a separately provided computer R (as in the case of service instances D₁I₁, D₂I₁, and D₂I₂) or on a computer R on which an agent A is executed (as in the case of service instance D₃I₁). It is also possible that several service instances DI assigned to one service D run on one computer R.

Within each of the computer groups G1, G2, and G3, the respective agents A1, A2, and A3 control the corresponding services D1, D2, and D3. The agents A1-A3 are a software program that runs either exclusively on one of the computers, as in the case of the computer groups G1 and G2, or shares a computer with at least one of the service instances, as in the case of the computer group G3. The agents A manage the service instances DI assigned to each service D.

Each agent A is designed to decide, on the basis of given criteria specified for the service D it is managing, whether another service instance DI is necessary for providing the service. For this purpose, the agents A are connected to the service instances DI and have available means for detecting and evaluating the load on the service instances DI. If one of the agents A determines that the service D it is managing cannot satisfy user requests with the set, desired performance, it sends a request Rq to the central control unit Z as shown in FIG. 1 as an example for agent A1.

In this context, it could also be provided that the agents A determine whether the service D could also still be provided with an adequate performance with fewer than the currently active service instances DI, for example, after a decrease in user requests. The corresponding agent A then sends a (negative) request to the central control unit Z.

The agents A can also be designed to distribute user requests as a function of the load on the various service instances DI responsible for a service D and also of the performance of the service instances DI. Alternatively, this action could also be performed by a separate network load distributor.

In addition, the agents A could also be designed to perform error recognition and handling at the level of the service instances DI. This can mean, for example, that a no-longer functional service instance DI is identified and automatically stopped, optionally reinstalled, and restarted by the agent without the involvement of the central control unit Z or the orchestrator O. If such error correction is unsuccessful or if an error is identified that is localized not at the level of the service instance DI but at a higher level, for example, the operating system or the hardware of the computer R on which the allegedly defective service instance DI is running, then the error correction responsibility of an agent A is exceeded and this is designed to send a corresponding error message to the central control unit Z. In this way, a natural responsibility hierarchy is produced in which the agents A have as much autonomy as necessary, in order to keep the complexity of the central instance low.

The task of the central control unit Z is to receive the requests Rq from the agents A and, based on information about the number and the type of services D to be provided and the number and type of computers R available in the multicomputer system, to determine a configuration Kmin that satisfies the requests Rq as much as possible. A configuration K designates a unique assignment of each computer R to exactly one of the computer groups G or the other computer group G0.

The information on the number and the type of services D to be provided and also on the number and type of available computers R is stored here in the data storage DS. The configuration Kmin determined by the central control unit Z is forwarded to the orchestrator O that outputs structure instructions S to the computers R of the multicomputer system, and optionally also to the agents A, similarly on the basis of the information stored in the data storage DS on the computers R and the services D to be provided. By means of the structure instructions S, computers R can be stopped, shut down, and restarted, wherein the starting process includes the loading of an operating system either from a local storage of the computer R or from a central data storage. Furthermore, it can be provided that the agents A are informed about whether and which computers R can also be used for providing the service D managed by each agent A or which computers can be taken from this service D.

The central control unit Z and the orchestrator O are, on their side, software programs that can be executed on a common computer or on separate computers that are not shown in FIG. 1. In another construction, the central control unit Z and the orchestrator O can also be executed on one or more of the computers R that they manage. It is conceivable that the tasks of the central control unit Z and the orchestrator O are integrated into one program that would then also be designated as a central control unit.

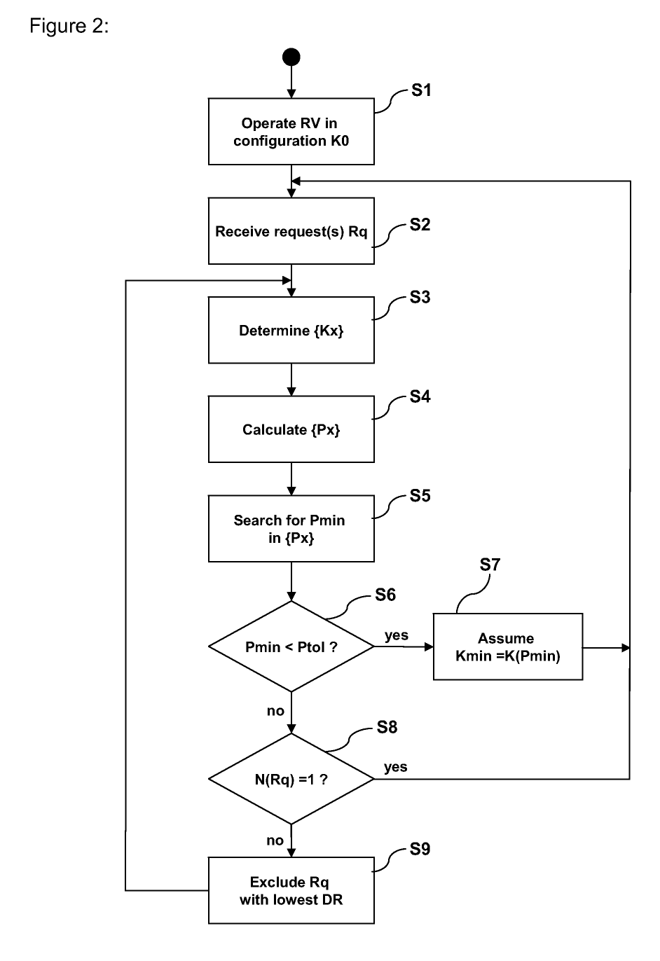

In connection with the flow chart of FIG. 2, a method for configuring a multicomputer system will be explained below in greater detail using the example of the multicomputer system shown in FIG. 1.

In a first step S1, the multicomputer system is initially operated in a configuration K0.

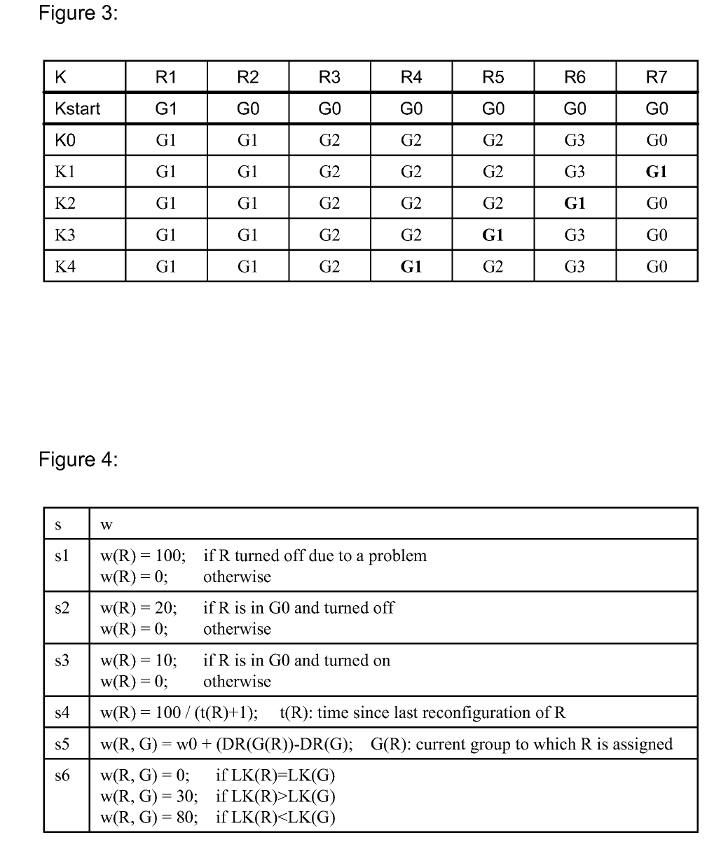

In the table shown in FIG. 3, various configurations K are shown for the multicomputer system shown in FIG. 1. One configuration K is shown in each line of the table. For differentiation, the various configurations K are provided with an index. In the columns of the table, for each of the computers R1-R7 of the multicomputer system, it is specified to which of the computer groups G available at the given point in time or the additional computer group G0 the corresponding computer R is assigned.

The execution of the configuration method according to the application assumes that at least one service D should be provided by the multicomputer system and for this service D a computer of a computer group G is assigned on which an agent A managing this service is executed. An example of a minimum configuration for executing the method according to the application is shown in the first line of the table of FIG. 3 as configuration Kstart. In the configuration Kstart, only the computer group G1 is provided for the provision of the service D1. The computer R1 for executing the agent A1 is assigned to the group G1. The other computers R2-R7 are unused and assigned accordingly to the other computer group G0. Starting from this configuration Kstart, the configuration method would perform a required assignment of the computers R2-R7 to the computer group G1 with reference to the requests Rq of the agent A1. If additional services D are to be provided by the multicomputer system, such as, for example, the services D2 and D3, the corresponding computer groups G2 and G3, to each of which at least one computer R is to be assigned manually for running the corresponding agents A2 and A3, are to be specified by a system administrator. Furthermore, this administrator is to start agents A2 and A3. The required assignments of computers R to the computer groups G2 and G3 is then automatically performed again by the configuration method described here. In this way, for example, starting from the configuration Kstart, the multicomputer system could have reached the configuration K0 shown in FIG. 1 and listed in the second line of the table in FIG. 3.

Below, the method shall be described starting from this configuration K0 of the multicomputer system RV. When the multicomputer system is operating in the configuration K0, the Web service D1, the database service D2, and the backup service D3 are provided by the computers R2, R4, R5, and R6 assigned to the computer groups G1-G3, respectively. The agents A1-A3 monitor the services D1-D3 in order to determine whether the services D1-D3 are performing with the requested performance. For this purpose, performance parameters that are characteristic for a service D can be determined and compared to given values. For example, for the Web service D1, a maximum response time can be defined within which a request of a user of the multicomputer system should be answered. For other services, other parameters can be used for evaluation. Methods for this purpose are known from the state of the art and are not the subject matter of this application.

If one of the agents A1-A3 recognizes that the service for which it is responsible is not being provided with sufficient quality, in a step S2, it sends a request Rq to the central control unit Z that receives the request. As an example, assume that the agent A1 identifies a reply time that is too long for the Web service D1, for example, based on an increasing number of users of the multicomputer system. The agent A1 then sends the request Rq to the central control unit Z, wherein, by means of this request, it requests in the central control unit Z the assignment of another computer R to its computer group G1 for providing the service D1. In the embodiment shown, it is provided that only the assignment of exactly one additional computer R can be requested in a request Rq.

After receiving the request Rq in step S2, the central control unit Z then determines in step S3 a set of all possible configurations {Kx} with which the request of the agent A1 would be satisfied. The index x in a configuration K or an assessment value P is to be viewed below as a variable for an index. The shortened notation {Kx} designates a set of several configurations distinguishable by their indices. The set of all possible configurations {Kx} of the example is formed by the configurations K1-K4 that are listed in the middle part of the table in FIG. 3. These configurations K1-K4 emerge from the configuration K0 such that one of the computers R assigned to another computer group than G1 or assigned to the additional computer group G0 is taken from this computer group and assigned to the computer group G1.

For determining the set of possible configurations {Kx}, certain given initial conditions can be taken into consideration. For example, it can be provided that at least one computer R must remain for a computer group G for the execution of each agent A. For such a setting, the configuration K2 from the table of FIG. 3 would be excluded in advance and would not be included in the set of possible configurations {Kx} . However, it is also possible to allow such a configuration and to take into account the special features of this configuration in an evaluation of this configuration to be performed subsequently.

471 In an alternative arrangement of the method, it can be provided to receive several requests Rq and to process them together in the steps following step S2. For this purpose, for example, a queue can be provided in step S2 within which incoming requests Rq of different agents A are received and stored. It is also conceivable that requests Rq can be received in the background during a procedure, that is, during the steps S3-S9, and then processed in the next pass.

When several requests Rq are processed, in step S3, the set of all possible configurations {Kx} is determined as a composite set of all possible configurations that each satisfies at least one of the requests Rq. As an example, let two requests Rq be received during the processing time of a prior pass or during the waiting time during step S2, a request Rq1 of agent A1 and a request Rq2 of the agent A2. Both requests Rq1, Rq2 concern the assignment of one additional computer to the corresponding computer groups G1 and G2. Now, the set of possible configurations that satisfies the request Rq1 and the set of possible configurations that satisfies the request Rq2 will be determined. The set of possible configurations {Kx} with which the method will be performed in the further steps is then given from the composite set of the configuration sets satisfying the requests Rq1 and Rq2. In addition, it can also be provided to determine the set of possible configurations that satisfies both requests Rq1 and Rq2 and to include this in the composite set.

In a following step S4, an assessment value Px is determined for each configuration Kx from the set of possible configurations {Kx} . The assessment value Px reflects how well or how poorly the configuration Kx appears to be suitable for providing all of the requested services D of the multicomputer system RV. A suitable method for determining assessment values Px will be shown further below in detail. The assessment values Px can be defined so that a large number represents a well-suited configuration Kx or, conversely, a small number designates a well-suited configuration Kx. As an example, in the embodiments shown in the scope of this application, the latter is assumed, in which a smaller assessment value Px designates a more favorable configuration and a larger assessment value Px designates a less favorable configuration Kx. In such a case, the assessment values Px could be viewed as penalty values that increase with the unfavorability of configuration Kx.

In a step S5, from all of the defined assessment values Px, the smallest assessment value Pmin is sought as the superior assessment value. In the present case, the configuration K1 has the smallest assessment value Pmin=P1. This configuration for which the superior assessment value Pmin was calculated will also be designated below as the superior configuration Kmin.

In a step S6, the smallest assessment value Pmin found is compared to a given, tolerable assessment value Ptol. If Pmin is less than Ptol, then the method branches to a step S7 in which the superior configuration Kmin for which the smallest assessment value Pmin was calculated is assumed by the multicomputer system. To realize this, the superior configuration Kmin is forwarded from the central control unit Z to the orchestrator O. Then the orchestrator O determines one or more structure instructions S with reference to the configuration Kmin and the current configuration K0, and outputs them to the computers R.

A structure instruction S is here, for example, a configuration instruction to one of the computers R. By means of the structure instruction S, a computer R can be started, stopped, or shut down. Furthermore, it is possible to load an image of an operating system and thus to start the computer R with this operating system. Also, service instances DI could be loaded and started. The structure instruction S is thus suitable for restructuring the multicomputer system such that the most favorable, superior configuration Kmin determined by the central control unit Z is actually assumed.

In addition, an agent A can be informed via the structure instructions S as to which computer R is to be reassigned to a group G and which newly started or to-be-started service instance DI is to be made available for performing the service D. Alternatively, it is possible that this information is transmitted from the central control unit Z to the corresponding agents A. Here it can be provided that the service instances DI are loaded onto a computer R by means of the orchestrator O and the structure instructions S, but only started by the agent A. It is also possible that by means of the structure instructions S the computers R are only prepared, that is, an operating system is loaded and the computer R is thus started. The service instances are then loaded and started by the agent A. Here it is to be guaranteed that the newly provided service instance DI is registered by or in the agent A, so that the agent A can include this in the distribution of the requests to all of the service instances responsible for it and can monitor the correct processing of requests. Furthermore, it is provided that an agent A, by means of which a request Rq was positively decided, may place no other requests Rq until the computer R newly assigned to its computer group G is set up, a new service instance DI is started, and its impact on the quality with which the service D is provided can be determined.

The value for the maximum tolerable assessment value Ptol used in step S6 can be a fixed given value. The setting involves experience values for a certain multicomputer system and also services provided by this system. In an alternative construction of the method, it can also be provided, when the specified maximum tolerable assessment value Ptol is exceeded, to not directly reject the found configuration Kmin, but instead to present a decision on the assumption of this configuration Kmin to an administrator of the system. It is also conceivable to define an intermediate range for the assessment value Pmin within which the assumption of the configuration Kmin is initially set for manual arrangement. In addition, adaptive methods are conceivable with which the initially set thresholds are varied automatically with reference to a decision made by an administrator.

After successful restructuring of the multicomputer system, the method branches back to step S2 in which the central control unit is again ready to receive and process additional requests Rq.

If it was determined in step S6 that the smallest assessment value Pmin was not less than the given tolerable assessment value Ptol, the method branches to a step S8.

In step S8 it is queried how many requests (shown in the figure by N(Rq)) were involved in the set of possible configurations {Kx} determined in step S3.

If the determination of the set of possible configurations {Kx} was based on only one request, then the method branches back to step S2, without having to change the configuration in advance. Such a case occurs when even the most favorable of the possible configurations Kmin does not appear to be more suitable than the current configuration, or when the difference does not appear to justify the effort for the reconfiguration of the multicomputer system.

If the determination of the set of possible configurations {Kx} was based on more than one request, the method branches to a step S9 in which one of the input requests Rq is excluded. The method then branches back to the step S3 in which the set of possible configurations {Kx} is again determined, but now without taking into account the excluded request. Then steps S4-S6 are executed, wherein by excluding one of the requests Rq, a configuration can then be found that satisfies the criteria in step S6. This applies especially when the set of possible configurations {Kx} is determined in step S3 in the presence of several requests such that each of the configurations takes into account all of the current requests. After excluding one of the requests Rq, if the criteria in step S6 is still not satisfied, then other requests Rq can be successively excluded with a new execution of step S9 until either a configuration Kmin satisfying the criteria in step S6 is found or only one request Rq remains and the procedure is branched accordingly from step S8 back to step S2 without having assumed a new configuration Kmin.

The decision regarding which of the requests Rq is to be excluded in step S9 is made in the embodiment shown with reference to the relevance of the services D for which the corresponding requests Rq are placed. For example, services such as a database service are often a requirement for other provided services, such as a Web service or a service for operation management. The relevance of a service D can be set by a service relevance value DR that can be stored, for example, in the data storage DS shown in FIG. 1. In step S9, the request Rq submitted by agent A, whose managed service D has the lowest service relevance value DR, is excluded.

For complex multicomputer systems with a plurality of computers, determining the suitable configuration Kmin in steps S3-S5 requires a significant amount of time. In addition, it is also advantageous, in principle, to allow a certain waiting time to elapse after assuming a new configuration before calculating or performing a new restructuring. If a multicomputer system is reconfigured within too short a time span, the performance losses due to computer down times generated during the restructuring (time to shut down, load images, restart computers, etc.) can cancel out or even exceed the performance gains by the more favorable configuration. Furthermore, too frequent restructuring can lead to undesired oscillations in the configuration. It is therefore favorable to perform a new pass of the method after step S2 only after a certain waiting time.

The determination of the assessment values Px for a configuration Kx will be explained below in greater detail. The assessment values Px describe how favorable or unfavorable it would be to assume the associated configuration Kx for the multicomputer system. Mathematically, the assessment values Px can be defined as scalar values, whereby they can be easily compared to each other. In the scope of the application, smaller values of the assessment values Px should designate a more favorable configuration Kx, wherein the specified method obviously can also be performed with an inverted value sequence.

For determining the assessment values Px, a series of criteria is to be taken into account, for example, whether a computer R is functional, whether a computer R is already assigned to a different computer group G, and whether a computer R is definitely suitable based on its performance to execute a certain service instance DI. Furthermore, a priority sequence for the different services to be provided can be set and taken into account. In addition, it is possible and advantageous, in terms of a stable, automatic configuration method not tending toward oscillations in the configuration, to take into account information of the prior progression of restructuring actions. For example, it can be considered unfavorable if a computer R that was just recently assigned to a computer group G is now to be taken away from this computer group G.

In an advantageous arrangement of a method for determining assessment values Px, for each assignment of a computer R to a computer group G or to the additional computer group G0, a partial assessment value p(R, G) is determined, wherein the assessment value Px of a configuration Kx is produced as a sum of the partial assessment values p(R, G) for all combinations of a computer and a computer group G, G0 that form the combination Kx. The partial assessment values p(R, G) can be advantageously determined, in turn, additively with reference to a plurality of criteria and value points s assigned to these criteria. The designation “penalty points” in the case considered here thus has the effect that smaller assessment values designate more favorable configurations.

Penalty points s with a fixed penalty value w can be given, wherein the penalty value w is added to the partial assessment value p(R, G) when the criterion is net. Examples of penalty points s are listed in the table in FIG. 4. In the table, for the sake of simplicity, the criteria and also the penalty value w are specified for the different penalty points s that are numbered consecutively. Examples of penalty points s that are provided with a fixed penalty value and that are either taken into account or are not taken into account include the penalty value s1 with a high penalty value of 100, for example, that is levied when the corresponding computer is turned off due to a problem. The penalty point s2 is provided with a smaller penalty value of 20 is levied when the computer is turned off but is available, that is, is assigned to the additional computer group G0. The penalty point s3 is in turn provided with the smaller penalty value of 10, which is levied when the computer R is already turned on and available. The advantage of fixed penalty points s that either are levied or are not as a function of criteria is that their calculation can be performed quickly.

In addition, penalty points s with a variable penalty value w could be provided, wherein the penalty value could be dependent on the associated criteria and other parameters.

One example is the penalty point s4 whose penalty value w depends on when the corresponding computer R was last the subject of a reconfiguration (for example, a change in its group association). In the example shown, the penalty value decreases, starting from an initial penalty value of 100, inversely proportionally to the elapsed time t in min since the last restructuring.

Furthermore, penalty points s can be provided that take into account the relevance of the services D relative to each other with reference to the service relevance value DR. The penalty value s5 in the table in FIG. 4 is levied in a situation in which a computer is to be assigned to one group G but is already assigned to a different group G*. The penalty value of the penalty point s5 is then dependent on the difference in the relevance values DR of the services D to be provided by the groups G and G* and a certain given basic value w0 that is not set for this example.

Another example for a penalty point s with variable penalty value is given by the penalty point s6. Included in the calculation of the penalty value w is whether or to what extent the corresponding computer R is suitable, based on its performance, to provide a certain service. For this purpose, the computers R and the services D can be divided into performance classes LK that are stored in the data storage DS for the computers R and the services D. The division into the performance classes LK can involve, for example, the size of the working memory available in a computer or required by a service or a clock rate of the processor of the computer. The setup of a computer with respect to the performance of its network connection (for example, Ethernet, gigabit Ethernet, fiber channel) can also be reflected in the performance class LK.

If a computer R is assigned to the same performance class LK as the service D that is to be provided by the computer R based on its planned group association G, it is provided to levy the penalty value w=0. In contrast, if a computer R is assigned to a higher performance class than the service D (or the computer group G), a medium penalty value, for example, w=30, is levied. This medium penalty represents that it is not advantageous, at least for the entire system, to use an “over-qualified” computer for a service. In contrast, if a computer R is assigned to a lower performance class than the service D, then a high penalty value, for example, w=80, is levied. This high penalty value represents that it is unfavorable to provide an “overburdened” computer for a service that could conceivably not be performed or not performed adequately.

711 Due accounting for various parameters of the computers, the services, and the configuration history in the calculation rules, these calculation rules for the penalty points s lead to a mapping of a wide array of properties and requirements that are placed on the multicomputer system on a scalar magnitude of the assessment values P. These are comparable relative to each other with the aid of a simple comparison relation (larger/smaller), wherein competing demands of different services can be considered uniformly. The behavior of the automatic configuration method is thus predictable, and the risk of an undesired control behavior that results in, for example, oscillations, is reduced. The method is thus especially well-suited for automatic execution.

Damping a trend of oscillation in the automatic configuration method is also achieved by the two-stage decision process in that, initially from the set of possible configurations, the best suited configuration is sought (a relative criterion), but this is assumed only if it does not have too large an assessment value (an absolute criterion).

In multicomputer systems with a large number of computers R and many services D to be provided, the set of possible configurations {Kx}, however, can become extremely large, especially when taking into account several requests Rq. In such a case, in an alternative arrangement of the method, determining the actual most favorable configuration Kmin from the set of possible configurations {Kx} can be eliminated if a favorable configuration K is found that satisfies a given criteria. For example, a threshold Pok for the assessment values Px can be given that is advantageously smaller than the tolerable assessment value Ptol. If a configuration Kx is found whose assessment value Px falls below this threshold Pok, it can be assumed that the found configuration Kx is favorable, so that additional searches for even more favorable configurations possibly located in the set of possible configurations appears to be unnecessary. Consequently, the evaluation of additional configurations can be stopped and the corresponding configuration with the assessment value lying below the threshold was calculated can be assumed.

Another way for accelerating the determination of an assessment value lies in stopping this determination, during the addition of partial assessment values for determining an assessment value, when the sum of partial assessment values is already greater than the previous smallest assessment value.

Additional arrangements of the method according to the application, concern cases in which a unique minimum, or, in general, an extreme value, of the assessment values Px cannot be found in the set of possible configurations Kx. For example, it is conceivable that different configurations Kx could lead to the same minimum value of assessment value Px. In such a case, the service relevance value DR of the service D that was favored by one of the configurations Kx could be used as a decision criterion. Another possibility consists of excluding all requests of an agent A that relates to the service D with the lowest service relevance value DR from the set of possible configurations {Kx}, if a unique minimum of the assessment values Px cannot be found. If necessary, this can be performed successively with remaining agents or services. In the embodiment shown in FIG. 2, this can be achieved in step S6, in which the process is branched to step S8 not only when the minimum assessment value Pmin found exceeds the tolerable assessment value Ptol, but also when Pmin is not a unique minimum of only one configuration Kx.

Other arrangements of the configuration method concern the task distribution between the agents A and the central control unit Z. Preferably it is provided that the agent A automatically monitors the computers R assigned to its computer group G and the service instances DI running on these computers and also performs, in this scope, a possible error correction, for example, the end and restart of a service instance DI. For some services D to be provided, a management unit is already made available by the creator of the service instances DI, wherein this management unit can execute tasks comparable to the agent according to the application. Functions that are relevant for the agent according to the application and that cannot be performed by such an already available management unit can then be taken over by the central control unit Z. Furthermore, it is possible that an already available management unit does indeed have the necessary functionality, but requests Rq cannot be created in suitable form. It is conceivable, for example, that a management unit is already designed to monitor its registered service instances DI with respect to their performance and to be able to output the load on the service instances DI.

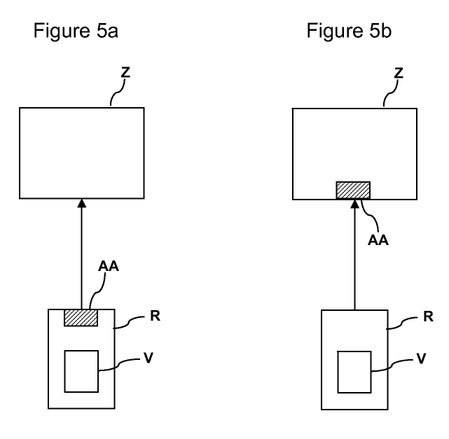

In each of FIGS. 5a and 5b, sections of a multicomputer system are shown in which a management unit V similar to the agent is connected to a central unit. An (agent) adapter AA is provided that receives the output of the management unit V, compares this output to the given criteria for a load, and, if necessary, places a request Rq to the central control unit Z. Such an adapter AA is thus used for converting or adapting the information output by the management unit V into a format-conforming request Rq that can be read by the central control unit Z. The adapter can be provided on the computer R executing an agent A, as shown in FIG. 5a, or can also be arranged in the central control unit Z, as shown in FIG. 5b.

Another group of advantageous constructions of the method according to the invention concerns the transmission and conversion of the most favorable configuration Kmin found. In the embodiment of FIG. 1, it is the task of the central control unit Z to determine the favorable configuration Kmin to assume and it is the task of the orchestrator O to realize the implementation of this configuration Kmin through corresponding structure instructions S. However, it is also conceivable to combine the function of the central control unit Z and the orchestrator O and to allow the central control unit Z to both find and also implement the configuration. In addition, it is conceivable to use a known orchestrator that is suitable, in principle, for configuring the computers of a multicomputer system and thus for restructuring the multicomputer system and to expand this orchestrator by an (orchestrator) adapter such that it can process a configuration Kmin in the format output by the central control unit Z.

In the method according to the application, the management of the computers is divided into the management performed by the agent A within the computer groups G and the management of the computer groups G by the central control unit Z. The relatively large autonomy that the agents A have with respect to the management of the computers R assigned to them produces high error tolerance in the multicomputer system, even for the loss of the central control unit Z. Therefore, for many applications it is unnecessary to construct the central control unit Z with high availability through redundancy. Even without a redundant design of the central control unit Z, high availability of the multicomputer system can already be achieved such that through suitable means, the correct function of the control unit Z is monitored and it is restarted, if necessary, during a failure.

The relatively large autonomy that the agents A have with respect to the management of the computers R assigned to them also permits the connection of many agents A to the control unit Z without it becoming too heavily loaded.

What is claimed is:

1. A method for configuring a multicomputer system with a plurality of computers, the method comprising:
assigning each computer to one of a plurality of computer groups, the computer groups comprising a computer group for each service to be provided and an additional computer group that includes all computers that are not assigned to a computer group for a service, each computer group for a service including at least one computer that runs an agent;
sending a request from an agent to a central control unit, wherein the request relates to the provision of at least one additional computer to the computer group that is assigned to the requesting agent;
determining a plurality of possible configurations of the multicomputer system that satisfy the request, wherein each possible configuration represents a unique assignment of each computer to either exactly one of the computer groups for a service or to the additional computer group;
determining an assessment value for each configuration for some of the possible configurations;
determining a superior assessment value from the set of determined assessment values and determining an associated superior configuration; and
configuring the multicomputer system in based on the determined superior configuration.

2. The method according to claim 1, wherein the request relates to the provision of exactly one additional computer.

3. The method according to claim 1, wherein the superior assessment value is an extreme value from the set of determined assessment values.

4. The method according to claim 1, wherein the superior assessment value is less than a given threshold.

5. The method according to claim 1, wherein a tolerance value is set and wherein, in configuring the multicomputer system, the multicomputer system is configured in the determined configuration only when the associated assessment value is less than the tolerance value.

6. The method according to claim 5, wherein the superior assessment value is less than a given threshold and wherein the threshold is less than the given tolerance value.

7. The method according to claim 1, wherein service relevance values are given for the services and wherein the assessment value for a possible configuration is determined as a function of the service relevance values.

8. The method according to claim 1, wherein performance classes that designate the suitability of a computer for providing a service are set for the computers and the services and wherein the assessment value for a possible configuration is determined as a function of the performance classes assigned to the computers and the services to be provided by the computers according to the assignments to computer groups.

9. The method according to claim 1, wherein the assessment value for a possible configuration is determined as a function of a time period that has elapsed since the reconfiguration of a computer provided in the possible configuration for providing a service.

10. The method according to claim 1, wherein each agent is designed to monitor the service instances providing the services within the computer group on the computers assigned to the computer group.

11. The method according to claim 10, wherein, by monitoring, each agent determines the quality with which the service is provided.

12. The method according to claim 11, wherein the agents are designed to send the request to the central control unit when the quality with which a service is provided by the service instances does not satisfy given criteria.

13. The method according to claim 1, wherein the central control unit is designed to receive and to store requests arriving within a given time period, wherein all of the received and stored requests are taken into account for determining the plurality of possible configurations of the multicomputer system.

14. The method according to claim 13, wherein each of the plurality of possible configurations satisfies at least one of the received and stored requests.

15. A multicomputer system for providing services, the system comprising:
a plurality of computers; and
a central control unit operationally coupled to the computers, the central control unit designed to execute a method comprising:
assigning each computer to one of a plurality of computer groups, the computer groups comprising a computer group for each service to be provided and an additional computer group that includes all computers that are not assigned to a computer group for a service, each computer group for a service including at least one computer that runs an agent;
sending a request from an agent to the central control unit, wherein the request relates to the provision of at least one additional computer to the computer group that is assigned to the requesting agent;
determining a plurality of possible configurations of the multicomputer system that satisfy the request, wherein each possible configuration represents a unique assignment of each computer to either exactly one of the computer groups for a service or to the additional computer group;
determining an assessment value for each configuration for some of the possible configurations;
determining a superior assessment value from the set of determined assessment values and determining an associated superior configuration; and
configuring the multicomputer system in based on the determined superior configuration.

16. A computer program that runs in a computer acting as a central control unit of a multicomputer system and that executes a method for the automatic configuration of the multicomputer system, the computer program having code to perform a method comprising:
assigning each computer to one of a plurality of computer groups, the computer groups comprising a computer group for each service to be provided and an additional computer group that includes all computers that are not assigned to a computer group for a service, each computer group for a service including at least one computer that runs an agent;
receiving a request from an agent at the central control unit, wherein the request relates to the provision of at least one additional computer to the computer group that is assigned to the requesting agent;
determining a plurality of possible configurations of the multicomputer system that satisfy the request, wherein each possible configuration represents a unique assignment of each computer to either exactly one of the computer groups for a service or to the additional computer group;
determining an assessment value for each configuration for some of the possible configurations;
determining a superior assessment value from the set of determined assessment values and determining an associated superior configuration; and
configuring the multicomputer system in based on the determined superior configuration.
